(19) United States
(12) Patent Application Publication
(10) Pub. No.: US 2026/0370734 A1
(43) Pub. Date: Nov. 19, 2026

(54) TECHNIQUES FOR GENERATING A CHANNEL PLATFORM USING A PLATFORM SERVICE LAYER FRAMEWORK

(71) Applicant: Capital One Services, LLC, McLean, VA (US)

(72) Inventors: Harvinder SINGH, Woodbridge, VA (US); Manikandan RAJARAM, Ashburn, VA (US); Nola YANG, Reston, VA (US); Elisabeth KAYTON, Charlotte, NC (US); Michael Joseph SIONS, Charlottesville, VA (US); Pawankumar PAWAR, Stone Ridge, VA (US); Akhila RAO, Bridgewater, NJ (US); Anish Kumar JAIN, Glen Allen, VA (US); Abhiram PADHI, Glen Allen, VA (US); Sandeep PATWARDHAN, Chandler, AZ (US); Robert COWELL, Baltimore, MD (US)

(21) Appl. No.: 19/661,559

(22) Filed: Apr. 28, 2026

Related U.S. Application Data
(60) Provisional application No. 63/807,971, filed on May 19, 2025.

(51) Int. Cl. H04L 67/63; G06F 3/0482

(52) U.S. Cl. CPC H04L 67/63; G06F 3/0482

(57) ABSTRACT

In some implementations, a system may receive a request to generate a channel platform associated with at least one channel type, wherein the channel platform is associated with an interface for communication with at least one user device. The system may receive a selection of a set of channel platform features to associate with the channel platform. The system may select one or more channel platform service assets from at least one set of channel platform service assets based on the selection of the set of channel platform features. The system may generate a platform service layer including the selected one or more channel platform service assets. The system may generate the channel platform associated with the interface for communication with at least one user device, wherein the channel platform is in communication with the platform service layer.

### CROSS-REFERENCE TO RELATED APPLICATIONS

This Patent Application claims priority to U.S. Provisional Patent Application No. 63/807,971, filed on May 19, 2025, and entitled “TECHNIQUES FOR GENERATING A CHANNEL PLATFORM USING A PLATFORM SERVICE LAYER FRAMEWORK.” The disclosures of the prior Applications are considered part of and are incorporated by reference into this Patent Application.

### BACKGROUND

User interfaces are software platforms that facilitate communication and interactions with a system, application, and/or website. User interfaces may enable communications between a user and a system, application, and/or website, such as via a self-service user interface, and/or may enable communication among multiple users. The visual components and interactions of the user interface are developed as part of the frontend of a system. Similarly, the backend of the system may include various components including data storage and processing, logic, and server communication.

### SUMMARY

In some implementations, a system for generating a channel platform using a platform service layer framework includes one or more memories; and one or more processors, communicatively coupled to the one or more memories, configured to: receive, from a developer device, a request to generate a channel platform associated with at least one channel type, wherein the channel platform is associated with an interface for communication with at least one user device; receive, from the developer device, a selection of a set of channel platform features to associate with the channel platform; select one or more channel platform service assets from at least one set of channel platform service assets based on the selection of the set of channel platform features, wherein the one or more channel platform service assets are in communication with the interface and with a backend component, and wherein each channel platform service asset of the selected one or more channel platform service assets is associated with at least one channel platform feature of the set of channel platform features; generate a platform service layer including the selected one or more channel platform service assets; and generate the channel platform associated with the interface for communication with at least one user device, wherein the channel platform is in communication with the platform service layer.

In some implementations, a method for generating a channel platform using a platform service layer framework includes receiving, from a developer device, a request to generate a channel platform associated with at least one channel type, wherein the channel platform is associated with an interface for communication with at least one user device; receiving, from the developer device, a selection of a set of channel platform features to associate with the channel platform; selecting one or more channel platform service assets from at least one set of channel platform service assets based on the selection of the set of channel platform features, wherein the one or more channel platform service assets are in communication with the interface and with a backend component, and wherein each channel platform service asset of the selected one or more channel platform service assets is associated with at least one channel platform feature of the set of channel platform features; generating a platform service layer including the selected one or more channel platform service assets; and generating the channel platform associated with the interface for communication with at least one user device, wherein the channel platform is in communication with the platform service layer.

In some implementations, a non-transitory computer-readable medium storing a set of instructions includes one or more instructions that, when executed by one or more processors of a system, cause the system to: receive, from a developer device, a request to generate a channel platform associated with at least one channel type, wherein the channel platform is associated with an interface for communication with at least one user device; receive, from the developer device, a selection of a set of channel platform features to associate with the channel platform; select one or more channel platform service assets from at least one set of channel platform service assets based on the selection of the set of channel platform features, wherein the one or more channel platform service assets are in communication with the interface and with a backend component, and wherein each channel platform service asset of the selected one or more channel platform service assets is associated with at least one channel platform feature of the set of channel platform features; generate a platform service layer including the selected one or more channel platform service assets; and generate the channel platform associated with the interface for communication with at least one user device, wherein the channel platform is in communication with the platform service layer.

### BRIEF DESCRIPTION OF THE DRAWINGS

FIG. 1 is a diagram of an example associated with techniques for generating a channel platform using a platform service layer framework, in accordance with some embodiments of the present disclosure.

FIG. 2 is a diagram of an example associated with techniques for generating a channel platform using a platform service layer framework, in accordance with some embodiments of the present disclosure.

FIG. 3 is a diagram of an example associated with techniques for generating a channel platform using a platform service layer framework, in accordance with some embodiments of the present disclosure.

FIGS. 4A-4B are diagrams of an example associated with techniques for generating a channel platform using a platform service layer framework, in accordance with some embodiments of the present disclosure.

FIG. 5 is a diagram of an example environment in which systems and/or methods described herein may be implemented, in accordance with some embodiments of the present disclosure.

FIG. 6 is a diagram of example components of a device associated with techniques for generating a channel platform using a platform service layer framework, in accordance with some embodiments of the present disclosure.

FIG. 7 is a flowchart of an example process associated with techniques for generating a channel platform using a platform service layer framework, in accordance with some embodiments of the present disclosure.

### DETAILED DESCRIPTION

The following detailed description of example implementations refers to the accompanying drawings. The same reference numbers in different drawings may identify the same or similar elements.

A user interface of a user device, such as a user interface provided by a web browser, may include a web page for presentation via the user device. The web page may include hyperlinks to various other web pages in one or more navigational menus. For example, the user interface of the web page may include visual elements, controls, and/or feedback mechanisms. Additionally, the user interface of the web page may include elements that enable interaction with the website and/or the underlying software and hardware. For example, the user interface may interact with the underlying software and hardware to obtain dynamic data, such as user account information or the status of a support ticket.

In some cases, an entity may create different channel platforms that enable the entity to develop and provide user interfaces that are customized for specific use cases and/or for different channel types. For example, an entity may create a channel platform that is associated with user incidents, reports, disputes, or the like. An incident, report, dispute, or the like may relate to an event such as a disputed or incorrect credit card charge, suspicious or fraudulent credit card usage, or a credit card charge flagged as disputed, suspicious, and/or fraudulent. Additionally, an entity may create a different channel platform that is associated with payments on a user account (e.g., payment of a credit card balance). Similarly, an entity may create a channel platform that is associated with different channel types that enable a user to access the channel platform via various channel types (e.g., web-based, application-based, or the like).

As a result, an entity may utilize different frontend technologies depending on the use case and/or channel type (e.g., mobile-based, web-based, application-based, or the like), where such frontend technologies may utilize different frameworks for interaction with backend technologies and/or backend components. For example, web-based user interface design and mobile-application-based user interface design may involve different visual components, may be designed differently depending on the screen type and size, and may utilize different input types (e.g., mouse and keyboard, touchscreen, or the like). Similarly, the entity may utilize different user interface frameworks depending on whether the user interface is utilized by a user or by an individual collaborating with the user. However, an entity may encounter difficulty in releasing user interfaces and/or providing consistent user experiences across different channel platforms and/or across different channel types. Similarly, an entity may encounter difficulty in reusing and/or repurposing user interfaces and/or channel platforms in new and/or different channel platforms or use cases. For example, where the user interface logic and elements are coded into a frontend interface associated with a channel platform (e.g., a web-based platform), it may be difficult to repurpose the user interface logic and elements into a new and different channel platform (e.g., a mobile application platform). Accordingly, the entity may create the new and different user interface and channel platform independently from the existing user interface and channel platform, resulting in an inefficient development process and/or the use of duplicative computing resources (e.g., memory and processing resources) for providing the user interface and channel platform.

Additionally, the implementation of different user interfaces and different channel platforms may result in a user experience that lacks parity and consistency, where a user may interact with different user interfaces across different use cases and/or depending on the type of interaction between the user and an entity. The lack of a seamless, coherent user interface may result in numerous problems for the user and the entity providing the user interface. For example, navigating through different user interfaces and/or platforms depending on the type of user interaction (e.g., disputing a credit card charge versus paying a credit card balance) creates a poor user experience, consumes excessive computing resources (e.g., processing resources and memory resources) that are needed for the user device to generate and display the web pages and that are needed for one or more server devices to serve the web pages to the user device, and consumes excess network resources that are needed for communication between the user device and the server device.

Some implementations described herein enable generation of a channel platform using a platform service layer network. In some implementations, a system may receive a request to generate a channel platform for a user interface associated with a channel type. Additionally, the system may receive a selection of channel platform features. For example, in some implementations, a developer device may be used to submit a request to generate a user interface and channel platform that includes a set of selected features to be included in the user interface associated with the channel platform. The system may select channel platform assets based on the received selection of channel platform features, where the channel platform assets are in communication with the user interface and with backend components. Additionally, in some implementations, each channel platform asset may be associated with one or more of the channel platform features received in the selection from the developer device. Furthermore, the system may generate a platform service layer that includes the channel platform service assets, where the system may generate a channel platform that is in communication with the platform service layer. For example, in some implementations, the system may provide a user interface associated with a channel platform, where multiple channel platforms may be in communication with backend services via the platform service layer. Additionally, in some implementations, the system may receive input information from a user device, where the system may dynamically update the channel platform based on decisioning information associated with an application programming interface (API) call that is performed in response to the input information. In some implementations, the channel platform may be in communication with an additional channel platform that is associated with a different channel type. For example, the channel platform may be in communication with a channel platform that is associated with a different use case, enabling logic and/or elements to be shared across channel platforms. Furthermore, in some implementations, the system may receive, from the developer device, a selection of a channel platform feature group, where the system may generate at least one channel platform service asset group based on the channel platform feature group and generate the platform service layer including the channel platform service asset group. For example, where multiple similar features are utilized in user interfaces associated with a channel platform, then the logic and/or elements may be grouped into a single platform service layer for access by the channel platform.

As a result, a user interface and channel platform may be generated and dynamically updated using a system that enables communication with backend components via a platform services layer. In this way, computing resources and/or network resources may be conserved by utilizing channel platform service assets that may be reused and repurposed at the platform service layer by multiple user interfaces and/or channel platforms, thereby reducing the use of duplicative computing resources for generating and providing different user interfaces and channel platforms. For example, where separate user interfaces and channel platforms are developed for different respective use cases, the system may enable reuse and repurposing of backend logic and elements for generating and maintaining the separate user interfaces and channel platforms. Additionally, by sharing functions as separate services or libraries (e.g., including rules and user interface elements), these shared functions may be reused and repurposed across user interfaces and channel platforms, thereby increasing development efficiency and reducing computing resource overhead where multiple user interfaces and channel platforms may rely on shared functions, as opposed to discrete, specialized functions unique to each user interface and platform. Similarly, utilizing a centralized backend system (e.g., including rules and user interface elements) to generate and maintain the user interface and channel platform may enable increased security and resiliency. For example, an entity may implement security measures and protocols in the single, centralized backend system, where any such security measures and protocols may be propagated to the respective user interfaces and channel platforms. In contrast, where security measures and protocols are separately implemented for each frontend system of multiple user interfaces and associated channel platforms, it may be difficult to ensure consistent security configurations, including consistent updates across user interfaces and channel platforms.

Additionally, the system may enable updates to the channel platform by utilizing API calls that include decisioning information and/or logic for updating the channel platform. For example, a user interface and channel platform may include configurations associated with APIs for specific user cases and/or user interactions, where the user interface may be dynamically updated based on the information returned from calls to the relevant APIs.

Furthermore, some implementations described herein make data easier to access by enhancing a user interface, thereby improving a user experience, enhancing user-friendliness of the user interface, and improving the ability of a user to use a user device. For example, some implementations described herein may enable a user to manage navigation within a single screen, thereby simplifying the user interface and providing a more efficient user experience, where the single screen interface may be modified and/or dynamically updated according to backend logic and user interface elements based on user interaction. Similarly, some implementations described herein may enable a user to manage navigation using a consistent user interface across different interaction channels (e.g., web-based, application-based, or the like) and/or use cases, thereby improving the user experience while reducing the computational resource overhead across use cases. For example, where a user encounters consistent user interfaces across interaction channels and/or use cases, the user may gain familiarity with the user experience, thereby enabling efficient navigation and interaction. The improved efficiency in navigation and interaction may result in a further decrease in computational resource overhead, where the user may be able to complete tasks in a shorter time period and with fewer inputs to the user interface. In contrast, where different user interfaces and/or channel platforms provide different user experiences using different backend rules and user interface elements, the system may provide additional data and information that is unique to each user interface and/or channel platform, and as a result is incompatible with different channels.

Similarly, where an entity updates a user interface and/or a channel platform, the system may enable the user interface and/or channel platform to remain consistent with separate user interfaces and/or platforms, where the communication with a centralized backend maintains parity across rules and user interface elements accessed by the different user interfaces and/or their associated channel platforms. The consistency and parity enable backend rules and elements to be reused and repurposed as user interfaces and channel platforms are updated, thereby reducing computational and network overhead, while maintaining a consistent user experience.

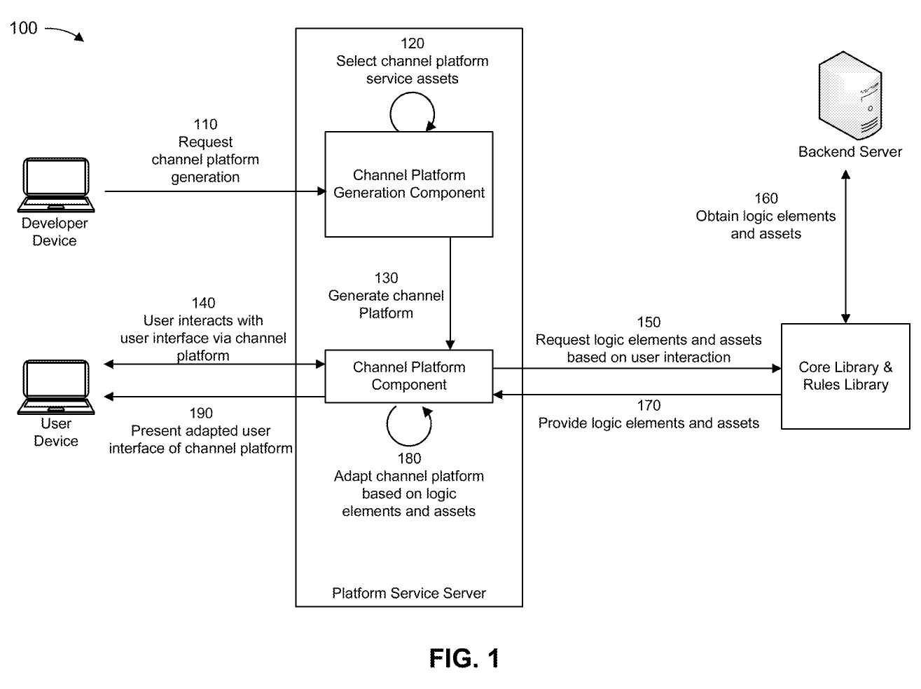

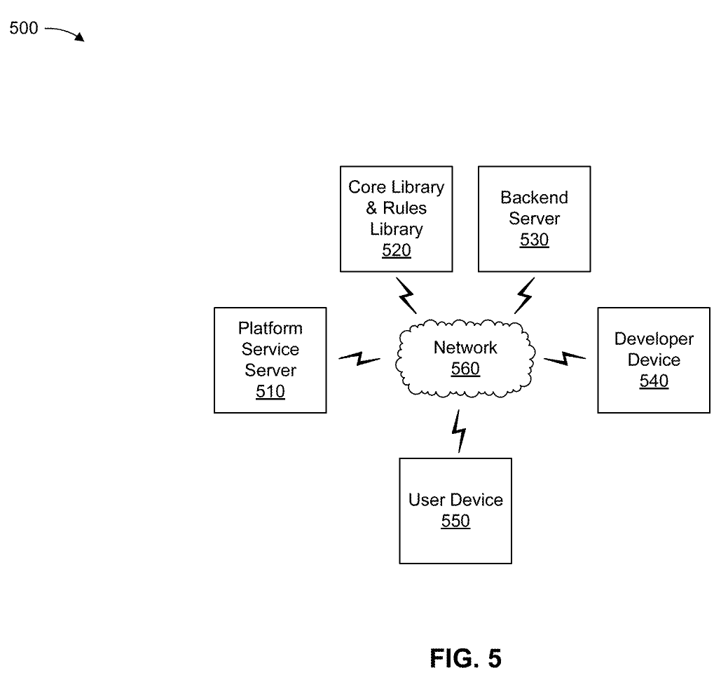

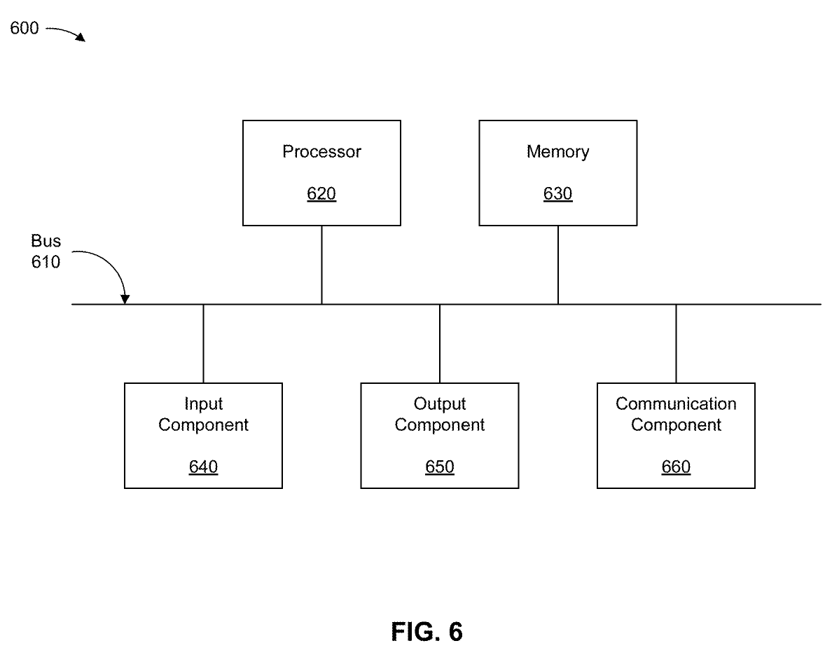

FIG. 1 is a diagram of an example 100 associated with techniques for generating a channel platform using a platform service layer framework. As shown in FIG. 1, example 100 includes a developer device, a platform service server, a core library and a rules library, a backend server, and a user device. These devices are described in more detail in connection with FIGS. 5 and 6.

As shown in FIG. 1, and by reference number 110, the developer device may initiate, and a channel platform generation component of the platform service server may receive, a request for generation of a channel platform. For example, the request for generation of the channel platform may be associated with a use case of an entity. Additionally, the request for generation of the channel platform may be associated with a third-party use case, where an entity may facilitate access to a system that enables third parties (e.g., freelance developers, unaffiliated developers, customers) to develop channel platforms associated with the entity. For example, an entity may permit third parties to develop components, elements, plugins, extensions, or the like that are compatible with one or more channel platforms associated with the entity.

Additionally, in some implementations, the channel platform may be associated with a user interface for communication with a user device. In some implementations, the request for generation of the channel platform may include a selection of a set of channel platform features that are to be associated with and/or included in the channel platform. For example, the channel platform features may include features, functionalities, and/or other user interface or channel platform elements.

As further shown in FIG. 1, and by reference number 120, the channel platform generation component may select channel platform service assets based on the request for generation of the channel platform. In some implementations, the channel platform service assets may be in communication with the user interface and with a backend component (e.g., a backend server, a core library and a rules library, or the like). Additionally, in some implementations, each selected channel platform service asset may be associated with at least one channel platform feature received in the request for generation of the channel platform. For example, where the channel platform generation component receives a request for platform generation that includes a selection of user interface features and/or functions, the channel platform generation component may select one or more channel platform service assets that may correspond to the selected user interface features. For example, the channel platform generation component may contain information associated with available channel platform service assets, including shared channel platform service assets that are currently in use by additional user interfaces and channel platforms. Additionally, in some implementations, the selected channel platform service assets may be enabled for communication with the user interface and with a backend component. For example, the selected channel platform service assets may enable API calls to backend services in order to obtain logic, user interface elements, and/or information, or to communicate with decisioning components or rules.

As further shown in FIG. 1, and by reference number 130, a channel platform component of the platform service server may generate a channel platform. In some implementations, the channel platform component may generate a platform service layer that includes the selected channel platform service assets and may generate the channel platform associated with the user interface. Additionally, in some implementations, the channel platform may be in communication with the platform service layer. Similarly, in some implementations, the platform service layer may enable communications between a user interface (e.g., on a user device) and backend services (e.g., rules, logic, user interface elements, or the like), where the backend services may be utilized to generate, maintain, and/or update the user interface based on user interaction. For example, the channel platform component may generate a platform service layer including the channel platform service assets, where the platform service layer may enable communications between the user interface and the backend component. For example, the channel platform service assets included in the platform service layer may enable API calls to backend services in order to obtain logic, user interface elements, and/or information, or to enable communication with decisioning components or rules.

Additionally, in some implementations, the channel platform component may generate the channel platform using shared channel platform service assets. For example, the channel platform component may access templates to set up the user interface and/or may access channel platform scaffolding to utilize the core library and the rule library, thereby enabling reusability and maintainability of shared channel platform service assets. For example, in some implementations, the scaffolding may include templates for creating channel platform service assets, libraries for shared functionality across channel platform service assets, templates for setting up server infrastructure, templates for monitoring dashboards, and/or templates for streaming data to third-party applications and/or services, among other examples.

As further shown in FIG. 1, and by reference number 140, a user may utilize a user device to interact with the user interface via the generated channel platform. For example, in some implementations, a user may request a web page and may interact with the web page user interface via a web browser, a mobile device, a mobile application, an interactive chat and/or chatbot system, or another suitable channel. In some implementations, the user interface may present user interface elements that are responsive to user interaction, including information associated with a user account, user information, information provided to the user interface (e.g., user input), intake queries, or the like.

As further shown in FIG. 1, and by reference number 150, the channel platform component of the platform service server may request logic elements and assets from the core library and the rules library based on the user interaction. For example, the user device may request information associated with a user account, including information associated with an inquiry and/or a dispute concerning a credit card charge or similar incident. Similarly, the user device may request information associated with a user profile of a web page and/or an application, including contact information, contact preferences, or other information associated with a user via the user profile.

As further shown in FIG. 1, and by reference number 160, the core library and the rules library may obtain logic elements and assets from a backend server. For example, the logic elements and assets may include decisioning information and user interface elements for dynamically updating a user interface in an intra-screen and/or a next-screen workflow. Similarly, by storing the logic elements and assets in connection with a backend server, the logic elements and assets may be accessed on a shared basis across channel platforms. As shown by reference number 170, the core library and the rules library may provide the logic elements and assets to the channel platform component. For example, where the user device requests information associated with a dispute concerning a credit card charge, the core library and the rules library may obtain information associated with the user account, the relevant credit card charge, transaction histories, among other examples. Additionally, the core library and the rules library may obtain logic and/or rules responsive to the user interaction and may obtain user interface elements for updating the user interface based on the logic and/or rules. For example, where the user answers a question regarding the relevant credit card charge, the logic and/or rules may dynamically update the user interface with a set of questions that are responsive to the user’s answer.

As further shown in FIG. 1, and by reference number 180, the channel platform component may adapt the channel platform based on logic elements and assets. For example, the logic elements may include decision information defining one or more conditions for selecting and providing assets to the user interface on the user device. For example, the logic elements may provide conditions for displaying user interface elements based on user responses to questions displayed in the user interface. For example, a user interface may be adapted based on a user indication of whether the user has ever provided a merchant with the user’s credit card information and/or a user indication of whether the user recognizes any details of a disputed credit card charge.

As further shown in FIG. 1, and by reference number 190, the channel platform component of the platform service server may present, and the user device may receive, the adapted user interface of the channel platform. In some implementations, the user interface may be adapted based on the logic elements and assets received from the core library and the rules library. For example, where a user indicates that the user has not provided credit card information to a merchant and that the user does not recognize any details of a disputed credit card charge, the user interface may be dynamically updated to include user interface assets that are responsive to that user input.

As described herein, some implementations enable generation and maintenance of a user interface and channel platform using shareable, reusable channel platform service assets accessible via a platform service layer. As a result, an entity may utilize a customizable platform that enables use cases to be mapped to individual infrastructures composed of modular libraries, thereby enabling consistent, standardized user experiences and system structures across multiple use cases or the like. Similarly, the system may enable interoperability between different user interfaces and different channel platforms for a consistent user experience and reduced computing resources for development. For example, development times may decrease where an entity may reuse and/or repurpose existing templates and framework for creating new channel platforms and user interfaces, thereby resulting in reduced computing resource (e.g., processing and memory usage) overhead. Additionally, the use of shared channel platform service assets may result in reduced complexity, where shared rules, logic, and assets may be added to and/or changed in different use cases without extensive frontend development, thereby enabling consistent updates across channel platforms.

As indicated above, FIG. 1 is provided as an example. Other examples may differ from what is described with regard to FIG. 1.

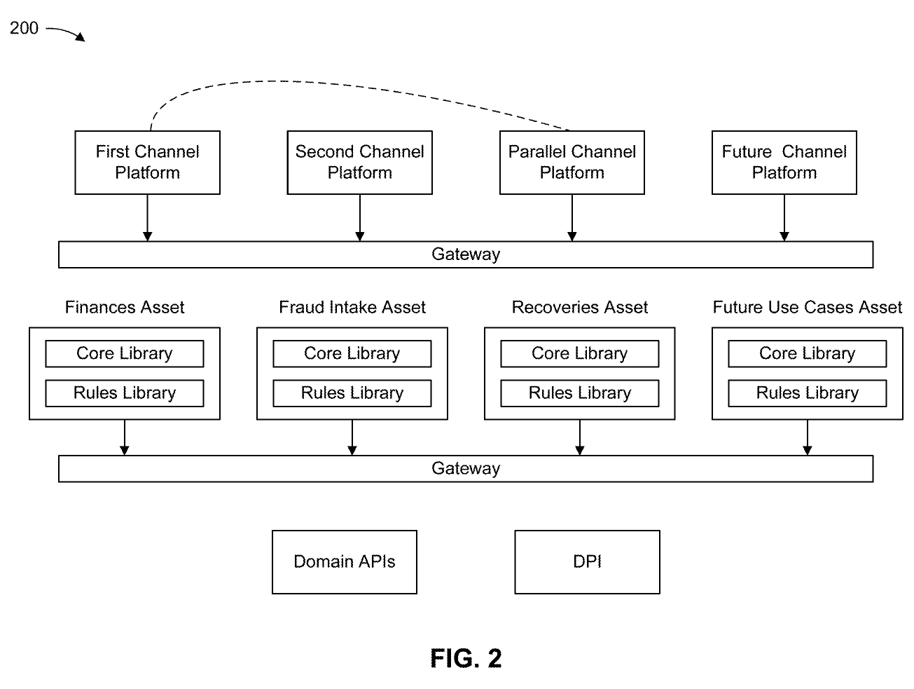

FIG. 2 is a diagram of an example 200 associated with techniques for generating a channel platform using a platform service layer framework.

As shown in FIG. 2, each channel platform of a set of channel platforms may be in communication with one or more assets via a first gateway. For example, a first channel platform may be in communication with a finances asset and a fraud intake asset based on the finances asset and the fraud intake asset being selected during generation of the first channel platform (e.g., at the channel platform generation component of a platform service server). For example, the finances asset and the fraud intake asset may be associated with the channel platform features that were received from the developer device in connection with the request to generate the channel platform. Similarly, a second channel platform may be in communication with the same set of assets or a different set of assets (e.g., with the fraud intake asset and the recoveries asset) based on the assets that were selected during generation of the second channel platform.

As an additional example, a parallel channel platform may be in communication with the first channel platform, thereby enabling the parallel channel platform to communicate with assets associated with the first channel platform, and enabling the first channel platform to communication with assets associated with the parallel channel platform. For example, a parallel channel platform may include a different set of assets from the assets associated with the first channel platform. For example, the parallel channel platform may include the recoveries asset, exclusively. In some implementations, where a user interaction includes a response that may invoke data associated with the recoveries asset (e.g., an asset associated with the parallel channel platform, but not associated with the first channel platform), the first channel platform may communicate with the recoveries asset to obtain rules, user interface elements, or the like from the recoveries asset when the first channel platform is in communication with the parallel channel platform.

Each asset may include a core library and a rules library and/or may be associated with one or more core libraries and/or one or more rules libraries. For example, the core library may include user interface elements that may be utilized by a channel platform. Similarly, for example, the rules library may include rules and/or logic that may be utilized by a channel platform. In some implementations, each asset may be in communication with one or more APIs (e.g., a domain API) and/or one or more direct programming interfaces (DPIs) via a second gateway. For example, a domain API may provide an interface for requesting logic, data models, and data associated with a specific use case. Additionally, a DPI may include a framework facilitating communication between a programming language associated with a backend system and other programming languages, where, for example, such communication may be utilized for legacy code integration and/or algorithm development. For example, where an entity generates a channel platform for a use case, the use case may be associated with specific assets that are in communication with one or more APIs and/or DPIs. Similarly, the channel platform may include a shared and/or generic request and response template enabling communication with one or more separate channel platforms and enabling new channel platforms to be integrated with one or more APIs and/or DPIs without separate development of requests and responses specific to the new channel platform.

Additionally, in some implementations, the channel platform may include one or more configurations that may be managed in a centralized backend system and may be external to the channel platform. For example, an entity may implement a “What to Check” configuration that includes a list of domain APIs that may be utilized for a specific use case (e.g., a use case associated with a channel platform and user interface). As an example, where a user is disputing a credit card charge associated with a transaction, the “What to Check” configuration may include a list of domain APIs that may be accessed to obtain information associated with the transaction. Additionally, an entity may implement a “What to Do” configuration that determines the next step (e.g., a next screen, an updated screen, or the like) of a user interface based on data points and/or features from the “What to Check” configuration. For example, the “What to Do” configuration may determine a user interface screen and/or an update to an existing user interface screen based on the data points returned in the “What to Check” configuration. For example, in some implementations, the domain APIs may include APIs related to credit card transactions, payment transactions, or other information, and/or decisioning associated with one or more channel platforms. Accordingly, these configurations (e.g., the “What to Check” configuration, the “What to Do” configuration, or the like) may be hosted and managed at the backend (e.g., as opposed to at the frontend, at the platform service layer, in the individual assets, or the like), the configurations may be efficiently switched and/or updated, and may enable different use cases (e.g., different channel platforms) to converge when future frameworks are developed.

Additionally, in some implementations, domain APIs may be onboarded to the channel platform generation framework through one or more libraries and library configurations that may be hosted in a backend system. A channel platform may have access to the APIs through one or more library configurations and/or through a platform services layer. For example, where a developer generates a channel platform using the platform service layer framework, the developer may configure the data needs of the channel platform from the domain APIs without separately developing access to the domain API. As an additional example, where an entity undertakes an entity-wide initiative for development of one or more channel platforms, the described techniques for generating a channel platform using the platform service layer framework may enable backend libraries to be adapted to target-state domain APIs for shared utilization across channel platforms (e.g., as opposed to each use case having to migrate to the new shared core configurations and frameworks). As a result, when different channel platforms (e.g., associated with different use cases) make a request to domain APIs, there is a shared exchange client rather than an exchange client for each channel platform (e.g., for each use case). Additionally, different development teams may add new domain APIs to one or more backend libraries to enable reuse and/or repurposing across channel platforms.

In some implementations, two or more assets (e.g., channel platform service assets) may be coupled for sharing in logical groupings associated with a feature (e.g., by channel platform feature, by use case, by domain, or the like). For example, where two or more assets share similar feature characteristics and/or use cases, the assets may be grouped together as a single resource, thereby enabling consistent updates across both assets where updates are made to the single resource. Similarly, where assets and/or their accompanying logic are grouped together (e.g., within a channel platform, by use case, by domain, or the like), computing resource overhead may be reduced by enabling consistent processes across group assets and/or logic, and by enabling updating and maintenance of assets and/or logic to be consistently and concurrently applied, preventing duplicative processing tasks.

Similarly, in some implementations, one or more assets (e.g., channel service assets) and/or their accompanying logic may be designed as an omnichannel asset and/or logic, where the omnichannel asset and/or logic are present across all channel platforms. For example, where shared user interface elements are to be utilized across all user interfaces and channel platforms of an entity, one or more assets and/or logic may be applied to each user interface and channel platform. By including omnichannel assets and/or logic, computing resource overhead may be further reduced by enabling consistency across all user interfaces and channel platforms, and by enabling updating and maintenance of assets and/or logic to be consistently and concurrently applied, preventing duplicative processing and development tasks. Additionally, by including shared assets and/or logic across user interfaces and channel platforms of an entity, the user experience may be simplified and improved, thereby enabling increased ease of navigation and a decrease in unnecessary computing and network resources from user interactions.

In some implementations, within a channel platform, each asset (e.g., a channel service asset) may correspond to a channel platform feature that is requested by the developer device for generation of the channel platform. For example, where the system receives a request for a specific channel platform feature (e.g., fraud intake), the channel platform may be generated to include a specific asset (e.g., a fraud intake asset) that corresponds to the requested channel platform feature. As a result, development teams may have increased flexibility in developing channel platforms tailored to specific use cases without conflicting overlap with other assets that may be unnecessary to the use case. Additionally, where each asset corresponds to a requested feature, the number of potential failure points may be decreased by enabling independent assets to continue functioning when one or more assets in a channel platform fail.

In some implementations, separate asset formats may be utilized for each channel type, where multiple channel types are utilized. For example, where a channel platform includes different channel types for web-based and application-based user interfaces, each asset (e.g., channel service asset) associated with the channel platform may include one or more asset types that are each specific to a channel type. For example, where a first channel platform includes a web-based user interface and an application-based user interface associated with fraud intake, there may be a fraud intake asset associated with web-based user interfaces and a fraud intake asset associated with application-based user interfaces. Additionally, or alternatively, a fraud intake asset associated with the first channel platform may include elements that are associated with the web-based user interface, elements that are associated with the application-based user interface, and/or elements that are associated with both the web-based user interface and the application-based user interface. For example, where assets are utilized that are specific to channel types (e.g., web-based, mobile-based, application-based, or the like), the probability of failure for a channel platform is decreased. For example, where an asset and/or elements of an asset associated with a web-based user interface fail, users may continue to access the corresponding asset and/or elements of the asset via an application-based user interface.

In some implementations, each asset may be managed by a use case team, development team, or the like within an entity. For example, where each asset is managed by a single use case team, there is a decreased probability that the asset will be updated and/or revised to include contradictory logic. In contrast, where an asset is managed by multiple use case teams, the logic asset may be updated to address two separate use cases, resulting in potentially contradictory logic that renders the asset incompatible with one or more of the use cases.

Additionally, in some implementations, each channel platform and/or each use case may be associated with a specific exchange API. For example, different channel platforms and/or use cases may utilize different API policies (e.g., different entitlements policies) as opposed to a single API serving multiple channel platforms and/or use cases. However, because a single endpoint API may be unable to be linked to multiple API policies, the system may utilize an exchange endpoint associated with each channel platform and/or use case. For example, the system may utilize a generic request and response template that is reusable across all channel platforms and/or use cases, thereby enabling customized access to the exchange API. Additionally, in some implementations, the generation of each exchange API associated with a channel platform and/or use case may be automated based on one or more request and response templates and/or frameworks.

In some implementations, the techniques described herein may enable data collection across various channel platforms, which may be utilized to update decisioning information, logic, and/or user interface elements in different channel platforms and/or in subsequent user interactions in the same channel platform. For example, data collected during user interaction with a user interface may be stored in one or more backend components associated with one or more channel platform service assets. The collected data may then be utilized to update new and/or different channel platforms. For example, user input collected during a merchant dispute process may be utilized in a subsequent merchant dispute process involving the same user and/or the same merchant, thereby simplifying the dispute resolution process and associated user interface steps. Similarly, user input collected during a merchant dispute process may be utilized in a subsequent fraud dispute process involving the same user and/or the same merchant, thereby simplifying the fraud resolution process and associated user interface steps.

As described herein, the techniques for generating a channel platform using a platform service layer framework may enable customized user experiences through automated workflow orchestration, thereby enabling user interactions that are dynamically adaptable to use cases and to user interaction with the user interface. For example, the platform service layer may enable customization and dynamic updating of user interfaces and/or channel platforms based on rulesets (e.g., a “What to Check” ruleset, a “What to Do” ruleset, or the like) that may determine the user interface elements and/or logic to be applied in response to user interaction. In this way, the user interface may be dynamically updated with relevant information based on user interaction, and where additional data and/or user interface elements are required, the platform service layer may facilitate communication with downstream APIs to gather the required information and to determine the next step(s) in a user interface workflow. Additionally, by utilizing channel platform service assets that may be reused and/or repurposed, updating and maintaining user interfaces across channel platforms and channel types (e.g., web-based, application-based, etc.) may be accomplished concurrently and consistently, thereby conserving computing and/or network resources by avoiding duplicative updates and maintenance. Additionally, the techniques described herein may enable data collection across various channel platforms, which in turn, may be utilized to update decisioning information, logic, and/or user interface elements in new and/or different channel platforms.

As indicated above, FIG. 2 is provided as an example. Other examples may differ from what is described with regard to FIG. 2.

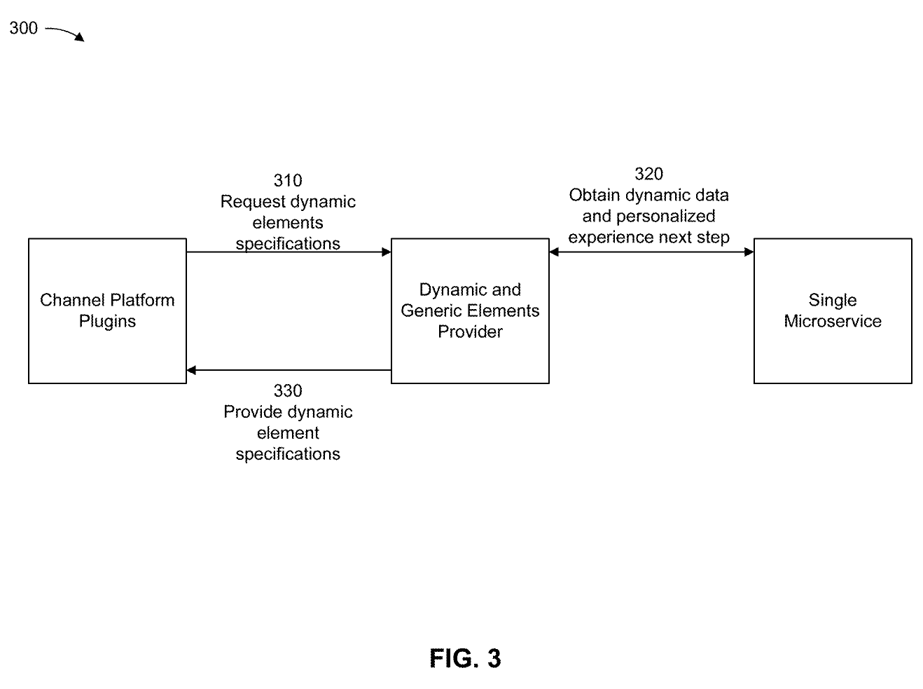

FIG. 3 is a diagram of an example 300 associated with techniques for generating a channel platform using a platform service layer framework.

In some implementations, a channel platform may be generated using a reusable pattern for server-based user interface frameworks via dynamic elements through a dynamic and generic elements provider. For example, as shown by reference number 310, a channel platform plugin (e.g., a plugin associated with a platform type, including a web-based platform, an application-based platform, or the like) may transmit, and a dynamic and generic elements provider (e.g., a provider located in a platform service layer, a backend component, or the like) may receive, a request for dynamic elements according to one or more specifications, and/or may request dynamic elements explicitly. For example, the channel platform plugins may be specific to one or more channel types of a channel platform (e.g., web-based, application-based, or the like), where the channel platform plugins may be capable of rendering elements associated with the plugins. Additionally, the dynamic and generic elements provider may serve as an element provider for mapping-oriented dynamic element experiences at a user interface. For example, the dynamic and generic elements provider may orchestrate data provider components and/or element utility components to produce specifications associated with an element. However, data provider orchestrations and/or configuration may be performed by a separate microservice in communication with the dynamic and generic elements provider, where this microservice may be associated with a platform service layer framework and/or a backend service in communication with the platform service layer framework.

As shown by reference number 320, the dynamic and generic elements provider may obtain dynamic data and personalized experience next step(s) from a single microservice. For example, the single microservice may utilize shareable, reusable libraries to collect data from various data sources based on the dynamic elements specifications. Similarly, the single microservice may utilize input from the dynamic elements specifications and/or other data points to determine responsive dynamic data and next steps. For example, in response to user input received via the request for dynamic elements specifications, the single microservice may provide logic and/or assets associated with a “Next Step” and or “Step Data” in order to dynamically update a user interface with the next steps in a workflow and/or the data associated with a next step in the workflow, responsive to the user input.

As shown by reference number 330, the dynamic and generic elements provider may provide dynamic elements specifications to the channel platform plugins. The dynamic elements specifications may include logic and/or assets that are responsive to the user input received via the request for dynamic elements specifications. For example, where a user interacts with a user interface associated with a channel platform, the dynamic and generic elements provider may dynamically update the user interface in accordance with the logic and/or assets provided by the dynamic elements specifications received from the dynamic and generic elements provider.

For example, where an integration for user interfaces enables dynamical updating of the user interface, different development teams and/or use cases may utilize a standardized framework to develop a channel platform using dynamic, reusable elements, thereby enabling each channel platform to be customized by a development team and/or according to a use case. Similarly, because the dynamic, reusable elements may be obtained from a provider of dynamic and generic elements (e.g., in communication with a microservice), different development teams and/or use cases may utilize shared elements rather than develop new elements specific to each development team and/or use case. Accordingly, the user interface may be dynamically updated in response to user interaction, using the logic and/or assets obtained from the dynamic and generic elements provider and the single microservice.

As indicated above, FIG. 3 is provided as an example. Other examples may differ from what is described with regard to FIG. 3.

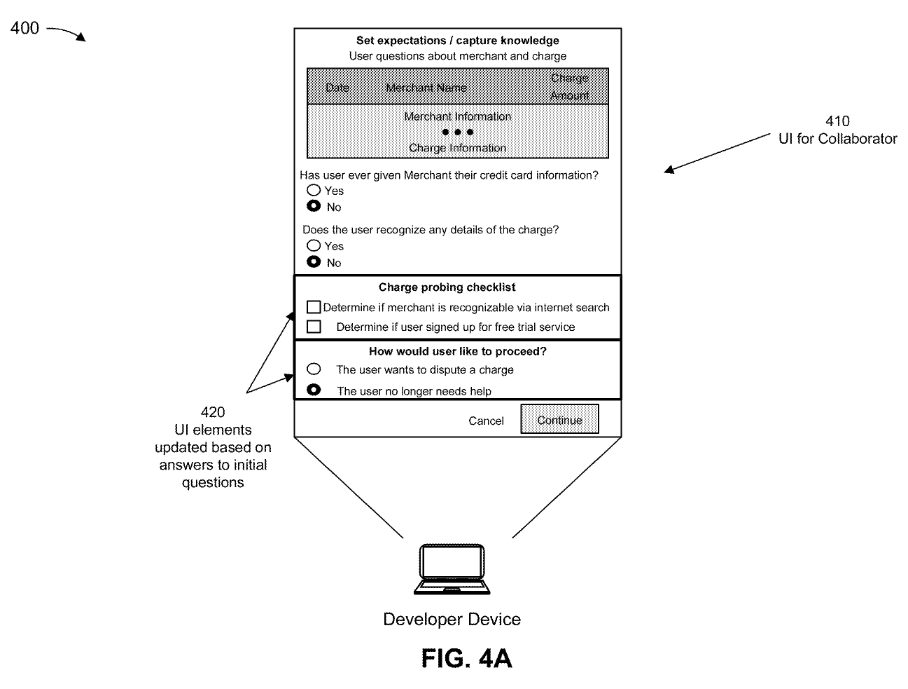

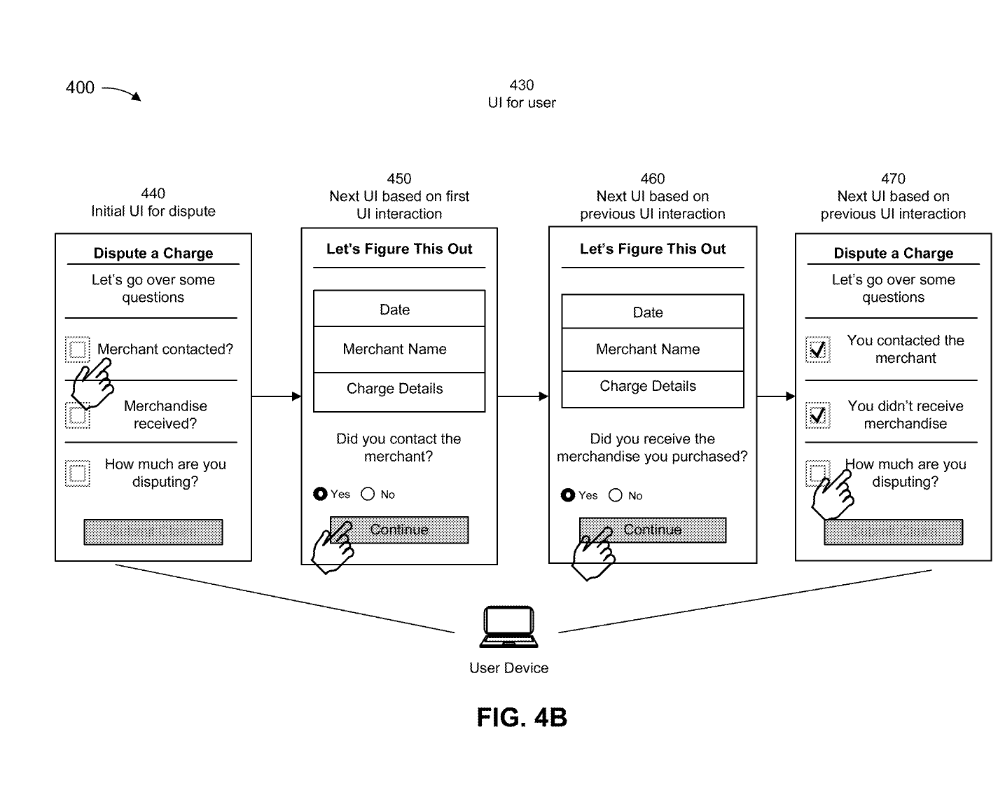

FIGS. 4A-4B are diagrams of an example 400 associated with techniques for generating a channel platform using a platform service layer framework. As shown in FIGS. 4A-4B, example 400 includes a developer device and a user device. These devices are described in more detail in connection with FIGS. 5 and 6.

As shown in FIG. 4A, a user interface 410 for a collaborator may include user interface elements for accessing and interacting with details related to a dispute for a credit card charge associated with a user. For example, in some implementations, the user interface 410 may be accessed via a developer device. The user interface 410 may include details concerning the credit card charge for which the user is initiating a dispute, including the charge date, merchant name and information, charge amount, charge information, or the like. In some implementations, the user interface may include intake questions and corresponding responses concerning the dispute. For example, the responses to the intake questions may be transmitted from a user device and received by the developer device. Additionally, or alternatively, the responses to the intake questions may be input into the user interface 410 by the collaborator.

As shown by reference number 420, one or more user interface elements may be displayed on the developer device based on interactions with the user interface and/or based on user context data. For example, the user interface 410 accessed by the developer device may be associated with a channel platform in communication with one or more channel platform service assets at a platform services layer, which may be in communication with one or more backend systems (e.g., via one or more APIs). In some implementations, the user interface 410 may be dynamically updated on an intra-screen basis, based on input associated with the user interface. For example, a channel platform service asset may utilize the user input to determine one or more next steps in response to the user input (e.g., according to logic associated with the channel platform service asset). In some implementations, the channel platform service asset may be in communication with one or more APIs, where the logic associated with the channel platform service asset may enable the channel platform service asset to obtain one or more elements to dynamically update the user interface 410 responsive to the user input. For example, the user interface 410 may be dynamically updated to include a “Charge probing checklist” and “How would user like to proceed” elements based on the responses to the questions “Has user ever given Merchant their credit card information?” and “Does the user recognize any details of the charge?”. As described herein, such user interface elements may be selected for display based on logic associated with one or more channel platform service assets that defines one or more conditions for providing the selected user interface elements to the developer device. As a result, the user interface 410 may be dynamically updated on an intra-screen basis to display the selected user interface elements.

Additionally, in some implementations, the channel platform service asset may be in communication with one or more APIs to obtain transaction information (e.g., from one or more backend components) and dynamically adjust the user elements in the user interface. For example, where a user account is associated with multiple credit card charges for a single merchant, the channel platform service asset may obtain transaction information (e.g., transaction date, transaction amount, or the like) associated with each credit card charge, and the user elements may be dynamically updated to include a question requiring the input as to which credit card charge the user is disputing with respect to the single merchant.

As shown in FIG. 4B, a set of user interfaces 430 for a user may include user interface elements for initiating a dispute concerning a credit card charge. For example, the set of user interfaces 430 may include a next-screen decisioning configuration, where each screen may be dynamically generated and/or updated based on input and/or interaction with a previous screen or with an initial request for a web page. Additionally, or alternatively, the set of user interfaces 430 may be accessed via a developer device, which may be a desktop computer, laptop computer, tablet, mobile phone, or the like. In some implementations, the set of user interfaces 430 may include an initial user interface 440 including a list of steps for disputing a credit card charge. Additionally, one or more channel platform service assets associated with the user interface and channel platform may perform an API call to determine whether there are circumstances that would prevent a dispute to the credit card charge. For example, where a dispute has been initiated, but not yet completed, for the credit card charge, the user may be prevented from initiating a new dispute with respect to the credit card charge. Similarly, where a dispute has been previously resolved for the credit card charge, the user may be prevented from initiating a new dispute with respect to the credit card charge.

In some implementations, following user interaction with the initial user interface 440, the user interface may be dynamically updated to display a next user interface 450 based on the first user interface interaction, including updated user interface elements. For example, the next user interface 450 may include one or more questions concerning the credit card charge and may include details concerning the credit card charge, including the charge date, merchant name and information, charge amount, charge information, or the like. As described herein, the user interface elements displayed in the next user interface 450 may include questions based on user interaction (e.g., user interaction with the initial user interface). For example, the next user interface 450 may query whether the user has contacted the merchant associated with the credit card charge. Additionally, in some implementations, the user elements (e.g., questions, prompts, input buttons, or the like) of initial user interface 440 may be generated in response to the answers input into the user interface 410 of FIG. 4A.

In some implementations, following user interaction with the user interface 450, the user interface may be dynamically updated to display a next user interface 460 based on the previous user interface interaction, including updated user interface elements. For example, the next user interface 460 may include one or more questions based on user interaction (e.g., user interaction with the previous user interface 450).

Additionally, in some implementations, one or more channel platform service assets may use the user input from both user interface 440 and user interface 450 to determine the appropriate channel platform service asset for the scenario associated with the dispute. For example, where the user indicates that the user contacted the merchant and that the user received the purchased merchandise, a disputes intake channel platform service asset may determine that the user interface may be dynamically updated in accordance with a dispute channel platform service asset (e.g., rather than a fraud channel platform service asset), where the user receiving the merchandise indicates that the case is a dispute claim and not a fraud claim. For example, the disputes intake channel platform service asset may make that determination based on downstream APIs and/or segmentation logic that is associated with the disputes intake channel platform.

In some implementations, following user interaction with the user interface 460, the user interface may be dynamically updated to display a next user interface 470 based on the previous user interface interaction, including updated user interface elements. For example, the next user interface 470 may include an updated list of steps for disputing the credit card charge, where the user interface elements have been updated based on the responses to questions in the user interface 450 and the user interface 460. The user may select the next item in the list of steps for disputing the credit card charge, and in response, the user interface may be dynamically updated to display elements associated with the next step for disputing the credit card charge.

As described herein, some implementations may enable efficient navigation in a user interface, including dynamically updating user interfaces based on one or more channel platform service assets associated with logic and/or user interface elements that may update a user interface in response to user interaction. As a result, user interfaces and/or channel platforms may be customized by a development team and/or according to use cases. In this way, computing resources and/or network resources may be conserved by reducing an amount of navigation performed by a user. Similarly, where channel platform service assets are reused and/or repurposed across channel platforms, computing resources and/or network resources may be conserved by reducing the amount of duplicative development work in generating channel platforms. Furthermore, the techniques described herein make data easier to access by enhancing a user interface, thereby improving a user experience, enhancing user-friendliness of a user interface, and improving the ability of a user to use the user device. For example, logic associated with one or more channel platform service assets (e.g., segmentation logic or the like) may be applied on an intra-screen basis, where user interface elements and input elements may be displayed and dynamically updated on a user interface based on interaction with the user interface, thereby enabling the system to adapt to user interactions. As a result, a user may perform relatively fewer steps to complete an interaction, where the user interface is dynamically updated to provide relevant content in response to the input provided by the user. Additionally, the described techniques may enable the centralized platform service layer framework to provide a consistent user experience across different user interface channels (e.g., web-based, application-based, or the like) and across different channel platforms, including across different use cases.

As indicated above, FIGS. 4A-4B are provided as an example. Other examples may differ from what is described with regard to FIGS. 4A-4B.

FIG. 5 is a diagram of an example environment 500 in which systems and/or methods described herein may be implemented. As shown in FIG. 5, environment 500 may include a platform service server 510, a core library and a rules library 520, a backend server 530, a developer device 540, a user device 550, and a network 560. Devices of environment 500 may interconnect via wired connections, wireless connections, or a combination of wired and wireless connections.

The platform service server 510 may include one or more devices capable of receiving, generating, storing, processing, providing, and/or routing information associated with techniques for generating a channel platform using a platform service layer framework, as described elsewhere herein. The platform service server 510 may include a communication device and/or a computing device. For example, the platform service server 510 may include a server, such as an application server, a client server, a web server, a database server, a host server, a proxy server, a virtual server (e.g., executing on computing hardware), or a server in a cloud computing system. In some implementations, the platform service server 510 may include computing hardware used in a cloud computing environment, such as one or more serverless components (e.g., one or more serverless functions).

The core library and the rules library 520 may include one or more devices capable of receiving, generating, storing, processing, and/or providing information associated with techniques for generating a channel platform using a platform service layer framework, as described elsewhere herein. The core library and the rules library 520 may include a communication device and/or a computing device. For example, the core library and the rules library 520 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the core library and the rules library 520 may store assets and rules utilizes the generate and/or update a channel platform using a platform service layer framework, as described elsewhere herein.

The server device 530 may include one or more devices capable of receiving, generating, storing, processing, providing, and/or routing information associated with techniques for generating a channel platform using a platform service layer framework, as described elsewhere herein. The server device 530 may include a communication device and/or a computing device. For example, the server device 530 may include a server, such as an application server, a client server, a web server, a database server, a host server, a proxy server, a virtual server (e.g., executing on computing hardware), or a server in a cloud computing system. In some implementations, the server device 530 may include computing hardware used in a cloud computing environment, such as one or more serverless components (e.g., one or more serverless functions).

The developer device 540 may include one or more devices capable of receiving, generating, storing, processing, and/or providing information associated with techniques for generating a channel platform using a platform service layer framework, as described elsewhere herein. The developer device 540 may include a communication device and/or a computing device. For example, the developer device 540 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The user device 550 may include one or more devices capable of receiving, generating, storing, processing, and/or providing information associated with techniques for generating a channel platform using a platform service layer framework, as described elsewhere herein. The user device 550 may include a communication device and/or a computing device. For example, the user device 550 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 560 may include one or more wired and/or wireless networks. For example, the network 560 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 560 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with techniques for generating a channel platform using a platform service layer framework. The device 600 may correspond to a platform service server, a core library and a rules library, a backend server, a developer device, and/or a user device. In some implementations, the platform service server, the core library and the rules library, the backend server, the developer device, and/or the user device may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

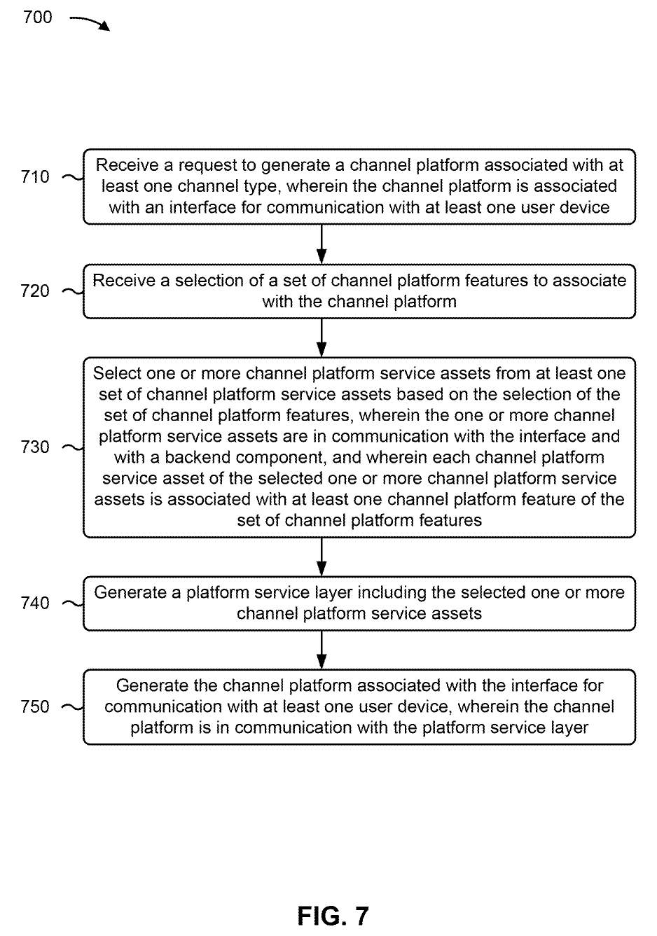

FIG. 7 is a flowchart of an example process 700 associated with techniques for generating a channel platform using a platform service layer framework. In some implementations, one or more process blocks of FIG. 7 may be performed by the platform service server 510. In some implementations, one or more process blocks of FIG. 7 may be performed by another device or a group of devices separate from or including the platform service server 510, such as the core library and the rules library 520, the backend server 530, the developer device 540, and/or the user device 550. Additionally, or alternatively, one or more process blocks of FIG. 7 may be performed by one or more components of the device 600, such as processor 620, memory 630, input component 640, output component 650, and/or communication component 660.

As shown in FIG. 7, process 700 may include receiving, from a developer device, a request to generate a channel platform associated with at least one channel type, wherein the channel platform is associated with an interface for communication with at least one user device (block 710). For example, the platform service server 510 (e.g., using processor 620, memory 630, input component 640, and/or communication component 660) may receive, from a developer device, a request to generate a channel platform associated with at least one channel type, as described above in connection with reference number 110 of FIG. 1. As an example, the system may receive a request to generate a channel platform for intake of disputes associated with one or more credit card charges. In some implementations, the channel platform is associated with an interface for communication with at least one user device. As an example, the request to generate a channel platform may be associated with a user interface for user interaction regarding the dispute, where the user interface may be associated with a developer device and/or a user device.

As further shown in FIG. 7, process 700 may include receiving, from the developer device, a selection of a set of channel platform features to associate with the channel platform (block 720). For example, the platform service server 510 (e.g., using processor 620, memory 630, input component 640, and/or communication component 660) may receive, from the developer device, a selection of a set of channel platform features to associate with the channel platform, as described above in connection with reference number 110 of FIG. 1. As an example, the system may receive a set of channel platform features to be associated with the user interface for intake of information related to the dispute of the credit card charge. For example, the requested set of channel platform features may include features related to intake of the dispute, fraud dispute features, and/or merchant dispute features.

As further shown in FIG. 7, process 700 may include selecting one or more channel platform service assets from at least one set of channel platform service assets based on the selection of the set of channel platform features (block 730). For example, the platform service server 510 (e.g., using processor 620 and/or memory 630) may select one or more channel platform service assets from at least one set of channel platform service assets based on the selection of the set of channel platform features, wherein the one or more channel platform service assets are in communication with the interface and with a backend component, and wherein each channel platform service asset of the selected one or more channel platform service assets is associated with at least one channel platform feature of the set of channel platform features, as described above in connection with reference number 120 of FIG. 1. As an example, in response to the requested set of channel platform features, the system may select one or more channel platform service assets that correspond to and/or satisfy the requested set of channel platform features. In some implementations, each channel platform service asset of the selected one or more channel platform service assets is associated with at least one channel platform feature of the set of channel platform features. As an example, the system may select a disputes intake asset, a fraud asset, and/or a merchant disputes asset, where the requested set of channel platform features includes features related to intake of the dispute, fraud dispute features, and/or merchant dispute features. In some implementations, the one or more channel platform service assets are in communication with the interface and with a backend component. As an example, each channel platform service asset may communicate with a backend server and/or a core library and a rules library to obtain user interface elements and/or logic responsive to user interaction. For example, based on the response to a question in the user interface, one or more channel platform service assets may obtain decisioning information and user interface elements for dynamically updating the user interface in response to the user input.

As further shown in FIG. 7, process 700 may include generating a platform service layer including the selected one or more channel platform service assets (block 740). For example, the platform service server 510 (e.g., using processor 620 and/or memory 630) may generate a platform service layer including the selected one or more channel platform service assets, as described above in connection with reference number 130 of FIG. 1. As an example, the system may generate a platform service layer that includes the channel platform service assets that correspond to each requested channel platform feature of the set of channel platform features (e.g., a disputes intake asset, a fraud asset, and/or a merchant disputes asset).

As further shown in FIG. 7, process 700 may include generating the channel platform associated with the interface for communication with at least one user device (block 750). For example, the 5 (e.g., using processor 620 and/or memory 630) may generate the channel platform associated with the interface for communication with at least one user device, wherein the channel platform is in communication with the platform service layer, as described above in connection with reference number 130 of FIG. 1. As an example, the system may generate user interfaces associated with a dispute resolution channel platform based on the channel platform service assets selected in response to the received selection of the set of channel platform features related to dispute resolution. In some implementations, the channel platform is in communication with the platform service layer. As an example, the user interface may be in communication with the platform service layer, which may include the selected channel platform service assets. For example, depending on user input in the user interface, the disputes intake asset may utilize segmentation logic to determine whether the credit card charge dispute is a potential fraud dispute or a potential merchant dispute. As a result, where a credit card dispute is determined to be a potential fraud dispute, one or more channel platform service assets (e.g., a fraud asset) may obtain logic elements and user interface elements associated with a potential fraud dispute, thereby enabling the user interface to be dynamically updated based on the obtained logic elements and user interface elements.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1, 2, 3, 4A, and/or 4B. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for generating a channel platform using a platform service layer framework, the system comprising:
one or more memories; and
one or more processors, communicatively coupled to the one or more memories, configured to:
receive, from a developer device, a request to generate a channel platform associated with at least one channel type,
wherein the channel platform is associated with an interface for communication with at least one user device;
receive, from the developer device, a selection of a set of channel platform features to associate with the channel platform;
select one or more channel platform service assets from at least one set of channel platform service assets based on the selection of the set of channel platform features,
wherein the one or more channel platform service assets are in communication with the interface and with a backend component, and
wherein each channel platform service asset of the selected one or more channel platform service assets is associated with at least one channel platform feature of the set of channel platform features;
generate a platform service layer including the selected one or more channel platform service assets; and
generate the channel platform associated with the interface for communication with at least one user device,
wherein the channel platform is in communication with the platform service layer.

2. The system of claim 1, wherein the one or more processors are further configured to:
receive, from the at least one user device, input information;
perform an application programming interface (API) call based on the input information,
wherein the API call is associated with the selected one or more channel platform service assets;
obtain an API output based on the API call,
wherein the selected one or more channel platform service assets includes decision information defining one or more conditions for updating the channel platform based on the API output; and
update the channel platform based on the decision information.

3. The system of claim 1, wherein the at least one set of channel platform service assets includes a set of platform libraries and a set of platform templates supporting a service associated with the interface.

4. The system of claim 1, wherein one or more channel platform features of the set of channel platform features is associated with one or more interface assets associated with the interface.

5. The system of claim 1, wherein each channel platform service asset of the selected one or more channel platform service assets is in communication with at least one of an application programming interface or a direct programming interface.

6. The system of claim 1, wherein the set of channel service assets includes decisioning information and at least one domain application programming interface (API), and
wherein the decisioning information includes a set of conditions for updating the channel platform based on one or more calls to the at least one domain API.

7. The system of claim 1, wherein the channel platform is in communication with at least one additional channel platform that is associated with an additional channel type.

8. The system of claim 1, wherein each channel platform service asset of the selected one or more channel platform service assets is associated with a different channel platform feature of the set of channel platform features.

9. The system of claim 1, wherein the one or more processors are further configured to:
receive, from the developer device, a selection of at least one channel platform feature group,
wherein each selected channel platform feature group includes a subset of the channel platform features in the set of channel platform features;
generate at least one channel platform service asset group based on the at least one channel platform feature group,
wherein each channel platform asset group includes the selected one or more channel platform service assets that are associated with the channel platform features of the channel platform asset group; and
generate the platform service layer including the one or more channel platform service asset groups.

10. A method for generating a channel platform using a platform service layer framework, comprising:
receiving, from a developer device, a request to generate a channel platform associated with at least one channel type,
wherein the channel platform is associated with an interface for communication with at least one user device;
receiving, from the developer device, a selection of a set of channel platform features to associate with the channel platform;
selecting one or more channel platform service assets from at least one set of channel platform service assets based on the selection of the set of channel platform features,
wherein the one or more channel platform service assets are in communication with the interface and with a backend component, and
wherein each channel platform service asset of the selected one or more channel platform service assets is associated with at least one channel platform feature of the set of channel platform features;
generating a platform service layer including the selected one or more channel platform service assets; and
generating the channel platform associated with the interface for communication with at least one user device,
wherein the channel platform is in communication with the platform service layer.

11. The method of claim 10, further comprising:
receiving, from the at least one user device, input information;
performing an application programming interface (API) call based on the input information,
wherein the API call is associated with the selected one or more channel platform service assets;
obtaining an API output based on the API call,
wherein the selected one or more channel platform service assets includes decision information defining one or more conditions for updating the channel platform based on the API output; and
updating the channel platform based on the decision information.

12. The method of claim 10, wherein the at least one set of channel platform service assets includes a set of platform libraries and a set of platform templates supporting a service associated with the interface.

13. The method of claim 10, wherein one or more channel platform features of the set of channel platform features is associated with one or more interface assets associated with the interface.

14. The method of claim 10, wherein each channel platform service asset of the selected one or more channel platform service assets is in communication with at least one of an application programming interface or a direct programming interface.

15. The method of claim 10, wherein the set of channel service assets includes decisioning information and at least one domain application programming interface (API), and
wherein the decisioning information includes a set of conditions for updating the channel platform based on one or more calls to the at least one domain API.

16. A non-transitory computer-readable medium storing a set of instructions, the set of instructions comprising:
one or more instructions that, when executed by one or more processors of a system, cause the system to:
receive, from a developer device, a request to generate a channel platform associated with at least one channel type,
wherein the channel platform is associated with an interface for communication with at least one user device;
receive, from the developer device, a selection of a set of channel platform features to associate with the channel platform;
select one or more channel platform service assets from at least one set of channel platform service assets based on the selection of the set of channel platform features,
wherein the one or more channel platform service assets are in communication with the interface and with a backend component, and
wherein each channel platform service asset of the selected one or more channel platform service assets is associated with at least one channel platform feature of the set of channel platform features;
generate a platform service layer including the selected one or more channel platform service assets; and
generate the channel platform associated with the interface for communication with at least one user device,
wherein the channel platform is in communication with the platform service layer.

17. The non-transitory computer-readable medium of claim 16, wherein the set of channel service assets includes decisioning information and at least one domain application programming interface (API), and
wherein the decisioning information includes a set of conditions for updating the channel platform based on one or more calls to the at least one domain API.

18. The non-transitory computer-readable medium of claim 16, wherein the channel platform is in communication with at least one additional channel platform that is associated with an additional channel type.

19. The non-transitory computer-readable medium of claim 16, wherein each channel platform service asset of the selected one or more channel platform service assets is associated with a different channel platform feature of the set of channel platform features.

20. The non-transitory computer-readable medium of claim 16, wherein the one or more instructions further cause the system to:
receive, from the developer device, a selection of at least one channel platform feature group,
wherein each selected channel platform feature group includes a subset of the channel platform features in the set of channel platform features;
generate at least one channel platform service asset group based on the at least one channel platform feature group,
wherein each channel platform asset group includes the selected one or more channel platform service assets that are associated with the channel platform features of the channel platform asset group; and
generate the platform service layer including the one or more channel platform service asset groups.
